(19) United States
(12) Patent Application Publication
(10) Pub. No.: US 2014/0314636 A1
(43) Pub. Date: Oct. 23, 2014

(54) Microchip

(71) Applicant: ROHM CO., LTD., Kyoto-shi (JP)

(72) Inventors: Shun Momose, Kyoto-shi (JP); Kenji Hamachi, Kyoto-shi (JP); Naoyuki Usagawa, Kyoto-shi (JP); Xin Wang, Kyoto-shi (JP); Hiroki Takeuchi, Kyoto-shi (JP); Yuki Shiritani, Kyoto-shi (JP); Tetsuya Ooka, Kyoto-shi (JP)

(73) Assignee: ROHM CO., LTD., Kyoto-shi (JP)

(21) Appl. No.: 14/251,836

(22) Filed: Apr. 14, 2014

(30) Foreign Application Priority Data
Apr. 18, 2013 (JP) 2013087320

(51) Int. Cl. B01L 3/00

(52) U.S. Cl. CPC B01L 3/50273
USPC 422/506

(57) ABSTRACT

There is provided a microchip including a fluid circuit composed of a space formed inside, and causing a liquid present in the fluid circuit to move within the fluid circuit by application of centrifugal force, the microchip including: an opening provided in a surface of the microchip and connected to the fluid circuit; a lid portion for opening and closing the opening; and a specimen take-in portion provided at the lid portion or in the opening, for taking in a specimen.

### BACKGROUND OF THE INVENTION

1. Field of the Invention

The present invention relates to a microchip with improved user's convenience, which can be suitably used in biochemical assay, chemical synthesis, environmental analysis or the like.

2. Description of the Background Art

In line with the recent increase in the importance of sensing, detecting or quantifying chemical substances or biological substances such as DNA, enzyme, antigen, antibody, protein, virus, cells, or the like in the field of medical care, health, food product, development of medicine, and the like, various biochips and microchemical chips (hereinafter collectively referred to as a microchip) that allow measurement thereof in a simplified manner have been proposed.

A microchip has many advantages in that a series of tests and analytical operations conventionally carried out at laboratories can be performed within a small chip and accordingly only a small amount of specimen and liquid reagent is required, reduction in cost is achieved, a reaction speed is fast, tests or analysis can be performed with high throughput, and test or analysis results can be obtained immediately at the site where the specimen has been collected.

There has been conventionally known a microchip including therein a flow channel network, which is called “fluid circuit (or micro fluid circuit)”, configured by a plurality of kinds of sites (chambers) for performing specific treatments for a specimen and a liquid such as a liquid reagent present in the circuit, and a flow channel connecting these sites (e.g., Japanese Patent Laying-Open No. 2007-285792).

### SUMMARY OF THE INVENTION

In test, analysis or the like of a specimen using the microchip including the aforementioned fluid circuit therein, this fluid circuit is used to perform various treatments such as discharge of a liquid reagent from a liquid reagent holding portion for housing the liquid reagent mixed with the specimen (or a specific component in the specimen) introduced into the fluid circuit, measuring the quantity of the specimen (or the specific component in the specimen) and/or the liquid reagent (i.e., movement to a measuring portion serving as a site for measuring the quantity), mixing of the specimen (or the specific component in the specimen) and the liquid reagent (i.e., movement to a mixing portion serving as a site for mixing these), and other movement from one site to another site.

The aforementioned various treatments performed for various liquids (the specimen, the specific component in the specimen, the liquid reagent, a mixture of two or more of them, or the like) in the microchip will hereinafter also be collectively referred to as “fluid treatment”. These various fluid treatments can be performed by applying centrifugal force to the microchip in an appropriate direction.

Test or analysis of the specimen using the microchip including the fluid circuit therein starts from introduction of the specimen (or the specific component in the specimen) from a specimen introducing portion of the microchip. There has been conventionally known a microchip in which the whole of a capillary having a specimen taken therein is loaded in a prescribed housing portion (corresponding to the aforementioned specimen introducing portion) of the microchip and thereby the specimen is introduced. One example of this microchip is a microchip disclosed in Japanese Patent Laying-Open No. 2007-285792 described above.

In the case of the microchip using the capillary to introduce the specimen, when the specimen is, for example, blood, a small amount of blood is first flown out onto a fingertip by using a lancet (instrument for blood collection), and thereafter, this blood is collected by the capillary made of glass and the like, and then, the whole of this capillary having the blood taken therein is loaded in the housing portion of the microchip.

However, the aforementioned conventional microchip has had the following problems, and thus, has had a room for improvement particularly about user's convenience:

1) the capillary is small and difficult to hold, and thus, collection of the specimen (taking the specimen in the capillary) is not easy;

2) the step of loading the capillary in the microchip is essential, which requires time and effort; and

3) when the microchip is offered to a market, it is necessary to package the capillary in addition to the microchip, which requires cost as well as time and effort.

The present invention has been made in view of the aforementioned problems and an object of the present invention is to provide a microchip with improved user's convenience, into which a specimen can be introduced in a simplified manner without preparing a capillary separately from the microchip.

The present invention provides a microchip described below.

[1] A microchip including a fluid circuit composed of a space formed inside, and causing a liquid present in the fluid circuit to move within the fluid circuit by application of centrifugal force, the microchip including:

an opening provided in a surface of the microchip and connected to the fluid circuit;

a lid portion for opening and closing the opening; and

a specimen take-in portion provided at the lid portion or in the opening, for taking in a specimen.

[2] The microchip according to [1], wherein the specimen take-in portion is disposed at the lid portion such that the specimen take-in portion is housed in the opening when the lid portion closes the opening.

[3] The microchip according to [1], wherein the specimen take-in portion is disposed within the opening.

[4] The microchip according to [1], wherein the lid portion is integrally molded with a member forming any portion of the microchip other than the lid portion.

[5] The microchip according to [4], wherein the lid portion and the member are coupled by a hinge.

[6] The microchip according to [1], wherein the lid portion is composed of a member different from a portion of the microchip other than the lid portion.

[7] The microchip according to any one of [1] to [6], wherein the specimen take-in portion includes a structure body for holding the specimen by capillary force.

According to the present invention, there can be provided a microchip with improved user's convenience. That is, the present invention can eliminate operational inconvenience and trouble of collecting a specimen using a capillary that is small and difficult to hold, and can save time and effort of loading the capillary having the specimen taken therein in the microchip.

In addition, the present invention eliminates the need for the capillary that has conventionally had to be prepared separately from the microchip main body, and thus, the present invention can be advantageous in terms of cost (such as manufacturing cost and packaging cost) as well.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A and 1B are schematic perspective views showing one example of a microchip according to a first embodiment.

FIGS. 2A, 2B, 2C and 2D are schematic perspective views showing a method for using the microchip shown in FIGS. 1A and 1B.

FIG. 3 is a schematic perspective view showing another example of the microchip according to the first embodiment.

FIG. 4 is a schematic perspective view showing an opening and a lid portion in still another example of the microchip according to the first embodiment.

FIG. 5 is a schematic perspective view showing one example of a microchip according to a second embodiment.

FIG. 6 is a schematic perspective view showing an opening and a lid portion in one example of a microchip according to a third embodiment.

FIGS. 7A and 7B are schematic views showing one example of a microchip according to a fourth embodiment.

FIGS. 8A and 8B are schematic views showing one example of a microchip according to a fifth embodiment.

FIGS. 9A, 9B and 9C are schematic perspective views showing a modification of the microchip according to the present invention.

FIG. 10 is a schematic perspective view showing another modification of the microchip according to the present invention.

FIGS. 11A and 11B are schematic perspective views showing still another modification of the microchip according to the present invention.

FIGS. 12A and 12B are schematic perspective views showing a further modification of the microchip according to the present invention.

FIGS. 13A and 13B are a schematic top view and a schematic side view showing a further modification of the microchip according to the present invention.

### DESCRIPTION OF THE PREFERRED EMBODIMENTS

### Overview of Microchip

A microchip according to the present invention is a chip that carries out various types of chemical synthesis, test, analysis or the like by using a fluid circuit provided in the microchip (space formed inside). By moving a liquid (a specimen, a specific component in the specimen, a reagent such as a liquid reagent, a mixture of two or more of them, and the like) in the fluid circuit to a prescribed site (chamber) in the fluid circuit by application of centrifugal force, the microchip according to the present invention can perform an appropriate fluid treatment for the liquid. For this purpose, the fluid circuit includes various sites (chambers) arranged at appropriate positions, and these sites are appropriately connected by a flow channel. In the aforementioned test or analysis, the aforementioned fluid treatment is typically pretreatment for test or analysis.

“Specimen” refers to a sample to be tested or analyzed that is introduced into the fluid circuit, or a specific component extracted from the sample, and “specimen” is typically in the liquid form. “Liquid reagent” refers to a reagent for mixing or reacting with the specimen, or treating the specimen. Normally, the liquid reagent is preliminarily contained in a liquid reagent holding portion of the fluid circuit before test or analysis of the specimen by the microchip.

Examples of the aforementioned sites (chambers) included in the fluid circuit can include: a liquid reagent holding portion for housing a liquid reagent; a separating portion for extracting a specific component from a specimen introduced into the fluid circuit; a specimen measuring portion for measuring the quantity of the specimen (as described above, the case in which the specimen is a specific component in the specimen is included, and the same is applied as well to the following description); a liquid reagent measuring portion for measuring the quantity of the liquid reagent; a mixing portion for mixing (or reacting) the specimen and the liquid reagent; a detecting portion for carrying out test, analysis or the like of the obtained mixed liquid (e.g., detecting or quantifying the specific component in the mixed liquid); a housing portion for temporarily housing a specific liquid; a waste liquid housing portion for housing an unnecessary liquid; and the like.

Normally, the microchip has, in one surface thereof, a reagent injection port that is a through hole extending to the liquid reagent holding portion, for injecting the liquid reagent into the liquid reagent holding portion. After the liquid reagent is injected, the reagent injection port is sealed by affixing a sealing layer (e.g., a plastic film, a label, a seal and the like having an adhesive layer on one surface thereof) onto a surface of the microchip.

As described below, the microchip according to the present invention has, in a surface thereof, an opening serving as a specimen introduction port, and this opening is connected to the fluid circuit.

A method for carrying out test, analysis or the like of the mixed liquid introduced into the detecting portion is not particularly limited. Examples of the method can include, for example, optical measurement such as a method for irradiating the detecting portion housing the aforementioned mixed liquid with light and detecting an intensity (transmissivity) of light passing through the detecting portion, and a method for measuring an absorption spectrum of the mixed liquid held in the detecting portion.

The microchip according to the present invention may have all of the sites (chambers) described above by way of example, or may not have one or more of the sites. Alternatively, the microchip according to the present invention may have a site other than these sites described by way of example. The number of the sites is not particularly limited, either, and the microchip according to the present invention can have one site or two or more sites.

Various fluid treatments in the fluid circuit such as extraction of the specific component from the specimen (separation of the unnecessary component), measuring the quantity of the specimen and the liquid reagent, mixing of the specimen and the liquid reagent, and introduction of the obtained mixed liquid into the detecting portion can be performed by sequentially applying centrifugal force to the microchip in an appropriate direction and sequentially moving the target liquid to a prescribed site arranged at a prescribed position. For example, measuring the quantity of the specimen and the liquid reagent by the measuring portions can be performed by introducing the specimen or the liquid reagent to be measured into the specimen measuring portion or the liquid reagent measuring portion having a prescribed capacity (amount equal to an amount to be measured) by application of the centrifugal force, and overflowing the excessive specimen or liquid reagent from the specimen weighing portion or the liquid reagent weighing portion. The overflowed specimen or liquid reagent can be housed in the waste liquid housing portion and the like connected to the specimen weighing portion or the liquid reagent weighing portion via the flow channel.

The microchip is placed at a device (centrifugal device) that can apply the centrifugal force, and thereby, the centrifugal force can be applied to the microchip. The centrifugal device can include a first stage that can freely rotate around a first axis, and a second stage that is arranged on the first stage and can freely rotate around a second axis on the first stage. The microchip is placed on the second stage, the second stage is rotated to arbitrarily set an angle of the microchip with respect to the first stage, and the first stage is rotated. As a result, the centrifugal force can be applied to the microchip in an arbitrary direction.

The microchip according to the present invention can be typically configured to include a first substrate and a second substrate stacked on and bonded onto the first substrate, and can be formed of, for example, the first substrate and the second substrate stacked on and bonded onto the first substrate (hereinafter, such a microchip formed of two substrates will also be referred to as “type A”). In this case, a groove (pattern groove) forming the fluid circuit is provided in a surface of the first substrate (surface on the side facing the second substrate). Both substrates are bonded together, with this groove located inside, and thereby, the fluid circuit serving as an internal space is formed. A groove forming the fluid circuit may further be provided in a surface of the second substrate (surface on the side facing the first substrate).

The microchip of type A (microchip formed of two substrates) is described in, for example, Japanese Patent Laying-Open No. 2009-258013 and the like. The configuration itself of the fluid circuit included in the microchip according to the present invention is not particularly limited and can, for example, be a configuration disclosed in this document.

The microchip according to the present invention may be formed by stacking and bonding a first substrate, a second substrate and a third substrate in this order (hereinafter, such a microchip formed of three substrates will also be referred to as “type B”). In this case, grooves forming the fluid circuits are provided in both surfaces of the second substrate arranged between the first substrate and the third substrate, and the microchip includes two-layer fluid circuits, i.e., a first fluid circuit formed by the first substrate and the second substrate, and a second fluid circuit formed by the second substrate and the third substrate. “Two-layer” means that the fluid circuits are provided at two different positions in the thickness direction of the microchip. These two-layer fluid circuits can be connected by one through hole or two or more through holes passing through the second substrate in the thickness direction. Grooves forming the fluid circuits may further be provided in surfaces of the first and third substrates (surfaces on the side facing the second substrate).

The microchip of type B (microchip formed of three substrates) is described in, for example, Japanese Patent Laying-Open No. 2009-133805 and the like. The configuration itself of the fluid circuit included in the microchip according to the present invention is not particularly limited and can, for example, be a configuration disclosed in this document. The microchip can also be configured by using four or more substrates.

A method for bonding the substrates together is not particularly limited, and examples of the method can include, for example, a method for melting a bonding surface of at least one substrate, of the substrates bonded together, and welding the substrates (welding method), a method for bonding the substrates with an adhesive, and the like. Examples of the welding method can include a method for heating and welding the substrates, a method for irradiating the substrates with light such as laser and welding the substrates by heat generated by light absorption (laser welding), a method for welding the substrates with ultrasonic waves, and the like. Among them, the laser welding method is preferably used.

A size of the microchip according to the present invention is not particularly limited, and the microchip according to the present invention can, for example, be approximately several centimeters to 10 centimeters square and approximately several millimeters to several centimeters thick.

A material of each of the aforementioned substrates constituting the microchip according to the present invention is not particularly limited. Thermoplastic resin can, for example, be used, such as polyethylene terephthalate (PET), polybutylene terephthalate (PBT), polymethylmethacrylate (PMMA), polycarbonate (PC), polystyrene (PS), polypropylene (PP), polyethylene (PE), polyethylene naphthalate (PEN), polyarylate resin (PAR), acrylonitrile butadiene styrene resin (ABS), vinyl chloride resin (PVC), polymethylpentene resin (PMP), polybutadiene resin (PBD), biodegradable polymer (BP), cycloolefin polymer (COP), and polydimethylsiloxane (PDMS).

In the microchip of type A, at least one substrate is preferably a transparent substrate in order to form the detecting portion for optical measurement using the detection light. The other substrate may be a transparent substrate or an opaque substrate. When laser welding is performed, the other substrate is preferably an opaque substrate because the opaque substrate can increase the light absorptivity. More preferably, the other substrate is a black substrate formed by making the substrate from the aforementioned thermoplastic resin and adding a black pigment such as carbon black to this thermoplastic resin.

In the microchip of type B, the second substrate arranged between the first substrate and the third substrate is preferably an opaque substrate, and more preferably a black substrate, from the perspective of the efficiency of laser welding. On the other hand, for the same reason as above, the first and third substrates are preferably transparent substrates.

A method for forming the groove (pattern groove) constituting the fluid circuit is not particularly limited, and examples of the method can include an injection molding method using a die having a transcription structure, an imprint method, a cutting work method, and the like. A shape and a pattern of the groove are determined such that the internal space has a desired appropriate fluid circuit configuration.

The microchip according to the present invention is a microchip configured as described above and including an opening provided in a surface of the microchip and serving as a specimen introduction port to a fluid circuit, a lid portion for opening and closing this opening, and a specimen take-in portion provided at the lid portion or in the opening, for taking in a specimen. In the microchip according to the present invention, the microchip itself has the specimen take-in portion that can take in the specimen by bringing the specimen into contact therewith. Therefore, the microchip according to the present invention can eliminate the conventional operational inconvenience and trouble of collecting the specimen using the capillary that is small and difficult to hold, and can save the conventional time and effort of loading the capillary having the specimen taken therein in the microchip.

In addition, the microchip according to the present invention has the lid portion. Therefore, scattering of the specimen can be reliably prevented even when the centrifugal force is applied to the microchip.

The present invention will be described below in more detail by describing embodiments. Although description may be given using any one of type A and type B in the following description of the embodiments, it is needless to say that the features are also applicable to the other type. All microchips according to the following embodiments can be suitably used for blood test.

### First Embodiment

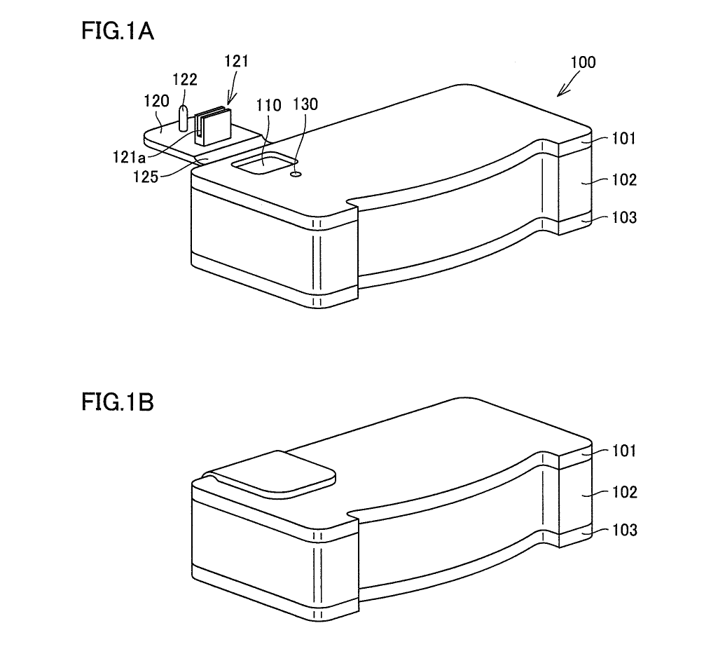

FIG. 1A is a schematic perspective view showing one example of a microchip according to the present embodiment, and shows a state in which a lid portion included in the microchip is open. FIG. 1B shows a state in which the lid portion is closed.

A microchip 100 shown in FIGS. 1A and 1B is a microchip of type B and is formed by stacking and bonding a first substrate 101, a second substrate 102 and a third substrate 103 in this order. Second substrate 102 can be a black substrate, and first and third substrates 101 and 103 can be transparent substrates. An opening 110 is provided in a surface of first substrate 101 (peripheral portion of the surface of first substrate 101) that is a part of a surface of microchip 100. This opening 110 is a through hole passing through first substrate 101 in the thickness direction, and a part of a fluid circuit is present below opening 110. Although not particularly limited, the part of the fluid circuit is, for example, a flow channel and the like for guiding a specimen to a separating portion for extracting a specific component (in the case of a microchip for blood test, a plasma component, a hemocyte component or the like) from the specimen, the flow channel being linked to the separating portion (the same is applied as well to the embodiments described below).

Microchip 100 includes a flat-plate-like lid portion 120 that can freely open and close opening 110. Lid portion 120 is coupled by a hinge 125 to the same member as the member having opening 110, i.e., first substrate 101. A specimen take-in portion 121 for taking in the specimen, and a protrusion 122 are provided on a rear surface of lid portion 120 (surface on the side facing first substrate 101 when lid portion 120 is closed). An insertion portion 130 on first substrate 101 is a hole into which protrusion 122 is inserted when lid portion 120 is closed, and protrusion 122 and insertion portion 130 are provided as necessary to allow lid portion 120 to be fixed in the closed state.

Specimen take-in portion 121 provided on the rear surface of lid portion 120 is disposed at such a position that specimen take-in portion 121 is housed in opening 110 when lid portion 120 is closed [see FIG. 1B].

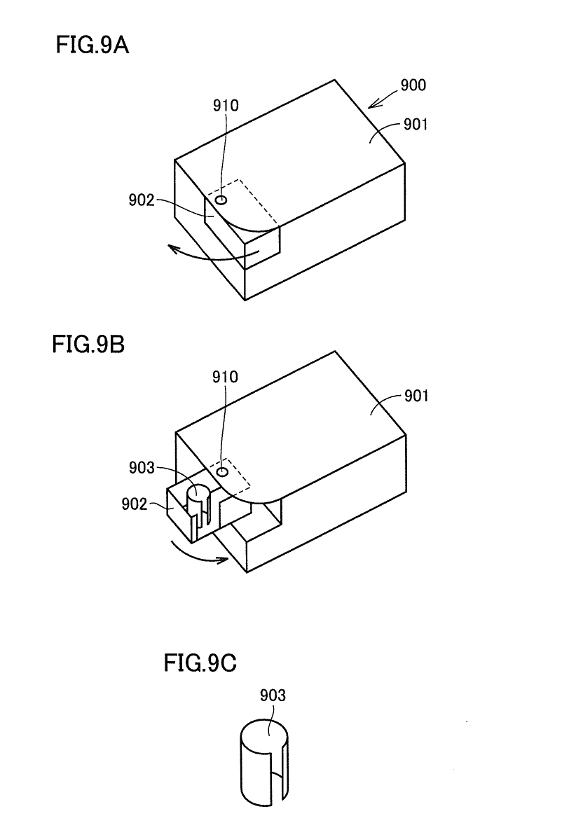

Specimen take-in portion 121 preferably includes, for example, a structure body that holds the specimen by capillary force. As such a structure body, specimen take-in portion 121 of microchip 100 according to the present embodiment has a structure body 121a in which a pair of plate-like bodies are arranged to face each other with a spacing therebetween. By setting a spacing between the pair of plate-like bodies to be, for example, approximately 200 to 2000 μm, and preferably 500 to 1000 μm, the capillary force on the specimen can be produced. However, the structure body that holds the specimen by the capillary force is not limited to the example shown in FIG. 1A, and may be, for example, a cylindrical structure body shown in below-described FIG. 9C, and the like. In this case, by setting an inner diameter of the structure body to be, for example, approximately 200 to 2000 μm, and preferably 500 to 1000 μm, the capillary force on the specimen can be produced. In order to produce the capillary force more effectively, a contact surface to the specimen, of the structure body that holds the specimen by the capillary force is preferably subjected to hydrophilizing treatment.

Another example of the structure body that holds the specimen by the capillary force can be a structure (brush-like structure) in which many protrusions are aligned at spacings that allow production of the capillary force. Alternatively, cotton or the like may be fixed to the rear surface of lid portion 120. Among the structure bodies described above, the structure body formed of the pair of plate-like bodies and the cylindrical structure body are advantageous because it is easy to visually check whether the specimen has been reliably taken in or not, and further, it is easy to visually check whether a prescribed amount or sufficient amount of specimen has been taken in or not. In the case of the structure body formed of the pair of plate-like bodies and the cylindrical structure body, it can be determined whether a prescribed amount or sufficient amount of specimen has been taken in or not, based on a determination criterion that a groove between the plate-like bodies or the cylindrical structure body is fully filled with the specimen, or a determination criterion of whether or not the specimen is housed to reach a marked line drawn preliminarily.

In microchip 100, lid portion 120 is coupled to first substrate 101 by hinge 125. Together with hinge 125, lid portion 120 is integrally molded with first substrate 101, and all of lid portion 120, first substrate 101 and hinge 125 can be made of the thermoplastic resin described above by way of example. Hinge 125 is formed to be thin, and thus, is easily bendable. Such integral molding of lid portion 120 (and hinge 125) and a microchip main body [portion of the microchip other than lid portion 120 (and hinge 125)] is extremely advantageous for reduction in the number of components constituting the microchip and reduction in cost related to assembly of the components. However, it is also possible to form lid portion 120 as a member different from the microchip main body and join this lid portion 120 to the microchip main body using hinge 125.

Although lid portion 120 is integrally molded with first substrate 101 in microchip 100, lid portion 120 may be integrally molded with second substrate 102 or third substrate 103.

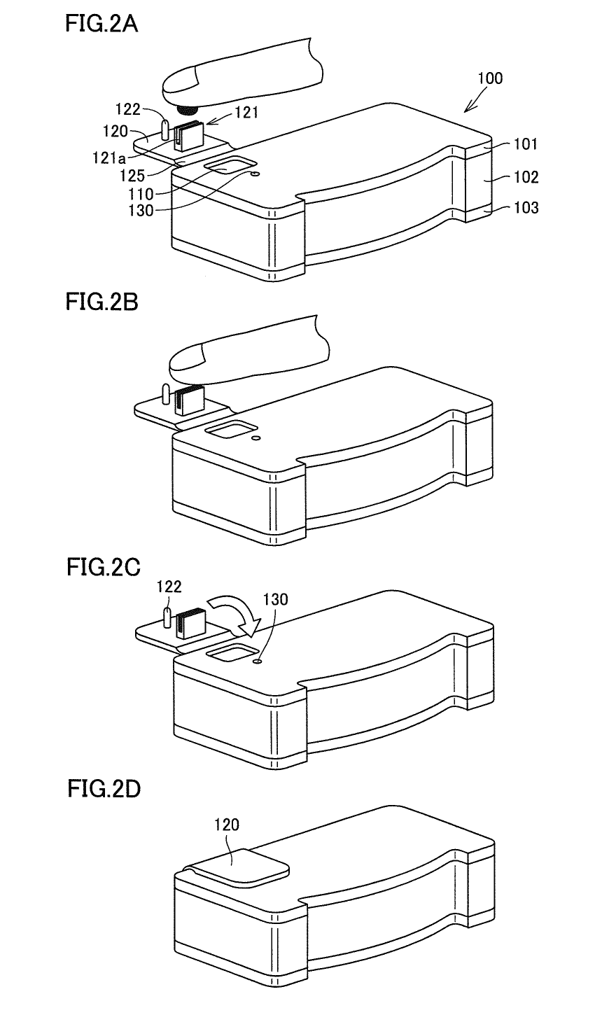

Next, a method for using microchip 100 will be described with reference to FIGS. 2A, 2B, 2C and 2D. First, lid portion 120 is opened to take specimen take-in portion 121 out of opening 110 [FIG. 2A]. Then, when the specimen is, for example, blood, a fingertip or the like having a drop of blood thereon is brought into contact with structure body 121a of specimen take-in portion 121 [FIG. 2B]. As a result, structure body 121a absorbs and holds the blood by the capillary force thereof.

In this step, specimen take-in portion 121 of microchip 100 is disposed at lid portion 120, and thus, the microchip main body does not become an obstacle and the fingertip or the like can be easily brought into contact with specimen take-in portion 121. That is, in microchip 100 according to the present embodiment, the fingertip or the like can be brought into contact with specimen take-in portion 121 that is arranged on the outer side than the microchip main body by opening lid portion 120, and thus, the contact can be achieved extremely easily.

Finally, protrusion 122 is fitted into insertion portion 130 and lid portion 120 is closed [FIGS. 2C and 2D]. Thereafter, test, analysis or the like (fluid treatment) is performed. When specimen take-in portion 121 is configured by the structure body that holds the specimen by the capillary force, the specimen basically remains held by the structure body even when lid portion 120 is closed. However, by application of centrifugal force to the microchip, the specimen is discharged from the structure body and introduced into the fluid circuit.

When the structure body that holds the specimen by the capillary force, which constitutes specimen take-in portion 121, is structure body 121a in which the pair of plate-like bodies are arranged with a spacing therebetween as shown in FIG. 1A, a direction in which the pair of plate-like bodies extend (direction in which the groove between the pair of plate-like bodies extends) is preferably a direction including a directional vector of the centrifugal force applied when the specimen is introduced into the fluid circuit, in order that the specimen can be discharged from structure body 121a by application of the centrifugal force.

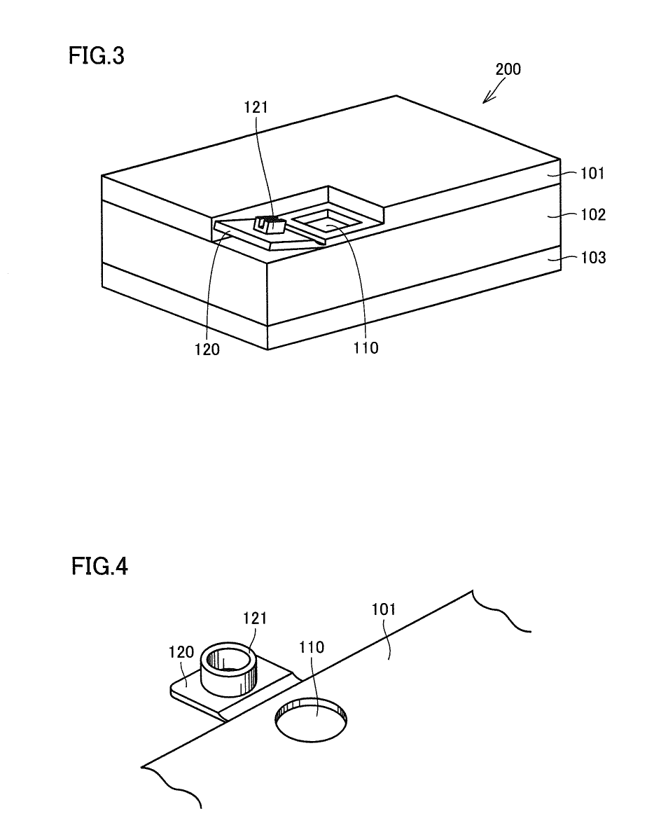

FIGS. 3 and 4 are schematic perspective views showing modifications of the present embodiment. A microchip 200 shown in FIG. 3 has a configuration similar to that of the microchip in FIGS. 1A and 1B except that a height position of a microchip surface portion having opening 110 formed therein, of a microchip surface (surface of first substrate 101) having opening 110, is lower than the other surface portion, and lid portion 120 is coupled by integral molding to this microchip surface portion (surface portion of first substrate 101) that is in the low height position.

Such a configuration is effective when it is undesirable for any reason that lid portion 120 on the microchip surface protrudes from the other microchip surface portion when lid portion 120 is closed. The present invention is not limited to the modification in FIG. 3, and a height position of lid portion 120 on the microchip surface when lid portion 120 is closed may be equal to a height position of the other surface portion.

A microchip shown in FIG. 4 has a configuration similar to that of the microchip in FIGS. 1A and 1B except that specimen take-in portion 121 is configured not by the structure body that holds the specimen by the capillary force but by a cylindrical structure body that does not show the capillary force. Such a structure body can be formed by making an inner diameter thereof larger than an inner diameter of the aforementioned cylindrical structure body that holds the specimen by the capillary force.

### Second Embodiment

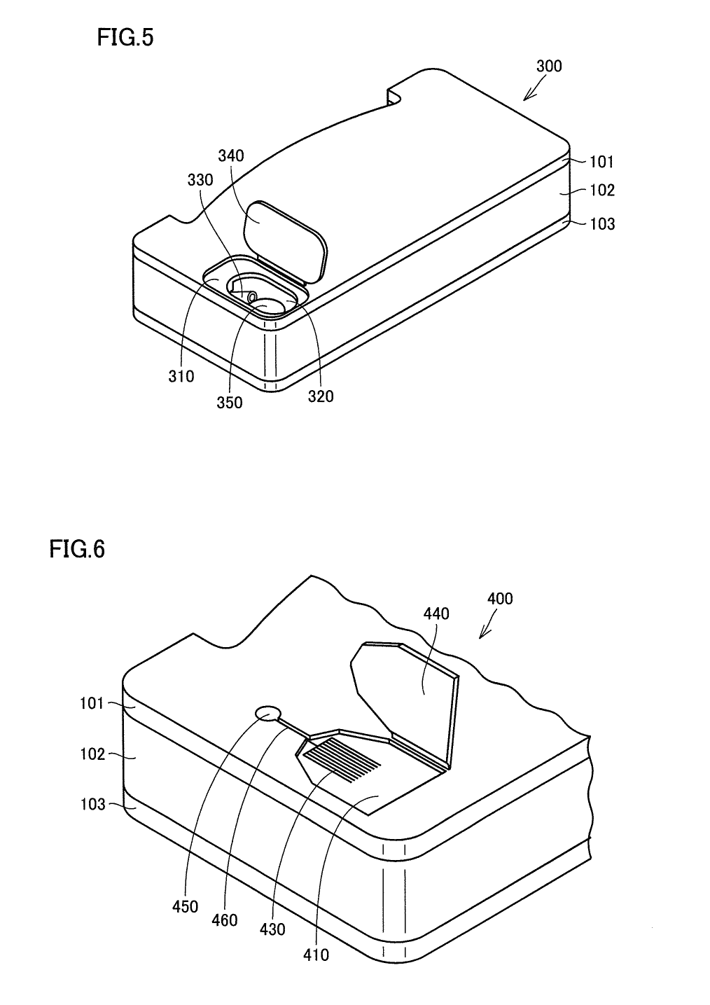

FIG. 5 is a schematic perspective view showing one example of a microchip according to the present embodiment. A microchip 300 shown in FIG. 5 is a microchip of type B and is formed by stacking and bonding first substrate 101, second substrate 102 and third substrate 103 in this order. Second substrate 102 can be a black substrate, and first and third substrates 101 and 103 can be transparent substrates. An opening is provided in a surface of first substrate 101 that is a part of a surface of microchip 300. This opening includes a first concave portion 310 provided in the surface of first substrate 101, and a second concave portion 320 provided in a bottom surface of first concave portion 310.

A specimen take-in portion 330 is disposed within this opening. More specifically, this specimen take-in portion 330 is a thin hollow tube and is obliquely arranged to pass through first substrate 101 such that one end of specimen take-in portion 330 protrudes into second concave portion 320 and the other end thereof is connected to a fluid circuit in microchip 300. A support body 350 that supports the one end of specimen take-in portion 330 protruding into second concave portion 320 may be provided within second concave portion 320.

Microchip 300 includes a flat-plate-like lid portion 340 that can freely open and close the opening. In microchip 300, lid portion 340 has substantially the same shape as that of first concave portion 310, and when lid portion 340 is closed, lid portion 340 fits into first concave portion 310 and the opening of second concave portion 320 is closed.

Similarly to microchip 100 shown in FIGS. 1A and 1B, lid portion 340 can be coupled by a hinge to the same member as the member having the opening, i.e., first substrate 101. Together with the hinge, lid portion 340 is integrally molded with first substrate 101, and all of lid portion 340, first substrate 101 and the hinge can be made of the thermoplastic resin described above by way of example. Although lid portion 340 is integrally molded with first substrate 101 in FIG. 5, lid portion 340 may be integrally molded with second substrate 102 or third substrate 103. It is also possible to form lid portion 340 as a member different from a microchip main body and join this lid portion 340 to the microchip main body using the hinge.

The thin hollow tube used as specimen take-in portion 330 is preferably a hollow tube that can pull in and hold the specimen by the capillary force when the specimen is brought into contact with the one end of specimen take-in portion 330 protruding into second concave portion 320, e.g., when the fingertip or the like having a drop of blood thereon is brought into contact with the one end of specimen take-in portion 330. For example, a commercially available capillary (made of glass), a tube having an inner wall subjected to anticoagulant treatment, and other tubes can also be used, in addition to a capillary of thermoplastic resin having an inner wall subjected to hydrophilizing treatment. Specimen take-in portion 330 can be incorporated at the time of fabricating the microchip (at the time of bonding the substrates together). Alternatively, specimen take-in portion 330 may be integrally molded with the substrates constituting microchip 300. The case in which specimen take-in portion 330 is integrally molded with the substrates constituting microchip 300 includes, for example, a case in which a flow channel itself linked to a separating portion, for guiding the specimen to the separating portion is specimen take-in portion 330 that can pull in and hold the specimen by the capillary force, and other cases.

As described above, in microchip 300 according to the present embodiment, specimen take-in portion 330 is provided on the microchip main body side (more specifically, within the opening of the microchip main body), not at lid portion 340. Similarly to the first embodiment, microchip 300 according to the present embodiment can eliminate the conventional operational inconvenience and trouble of collecting the specimen using the capillary that is small and difficult to hold, and can save the conventional time and effort of loading the capillary having the specimen taken therein in the microchip.

In addition, by forming first concave portion 310 and second concave portion 320 to have a relatively large area, the other portion of the microchip main body does not become an obstacle, and the fingertip or the like can be easily brought into contact with a tip of specimen take-in portion 330.

### Third Embodiment

FIG. 6 is a schematic perspective view showing an opening and a lid portion in one example of a microchip according to the present embodiment. A microchip 400 shown in FIG. 6 is also a microchip of type B and is formed by stacking and bonding first substrate 101, second substrate 102 and third substrate 103 in this order. Second substrate 102 can be a black substrate, and first and third substrates 101 and 103 can be transparent substrates. An opening is provided in a surface of first substrate 101 that is a part of a surface of microchip 400. This opening includes a first concave portion 410 provided in the surface of first substrate 101.

A specimen take-in portion 430 is disposed within this opening (first concave portion 410). More specifically, this specimen take-in portion 430 is configured by a region in which a plurality of linear grooves formed in first concave portion 410 are aligned in parallel. This region (specimen take-in portion 430) is linked by a flow channel (groove) 460 to a through hole 450 passing through first substrate 101 in the thickness direction. The specimen that has been taken into specimen take-in portion 430 passes through flow channel 460 and then through hole 450 and is introduced into a fluid circuit. A part of the fluid circuit is present immediately below through hole 450.

Microchip 400 includes a flat-plate-like lid portion 440 that can freely open and close the opening (first concave portion 410). In microchip 400, lid portion 440 has substantially the same shape as that of first concave portion 410, and when lid portion 440 is closed, lid portion 440 fits into first concave portion 410.

Similarly to microchip 100 shown in FIGS. 1A and 1B, lid portion 440 can be coupled by a hinge to the same member as the member having the opening, i.e., first substrate 101. Together with the hinge, lid portion 440 is integrally molded with first substrate 101, and all of lid portion 440, first substrate 101 and the hinge can be made of the thermoplastic resin described above by way of example. Although lid portion 440 is integrally molded with first substrate 101 in FIG. 6, lid portion 440 may be integrally molded with second substrate 102 or third substrate 103. It is also possible to form lid portion 440 as a member different from a microchip main body and join this lid portion 440 to the microchip main body using the hinge.

Specimen take-in portion 430 configured by the region in which the plurality of linear grooves are aligned in parallel is a hydrophilic structure body that can pull in and hold the specimen by the capillary force when the specimen is brought into contact with specimen take-in portion 430, e.g., when the fingertip or the like having a drop of blood thereon is brought into contact with specimen take-in portion 430. In order to provide such a function, a spacing between the linear grooves is preferably set to be, for example, approximately 200 to 2000 μm, and more preferably 500 to 1000 μm. In order to produce the capillary force more effectively, the region in which the plurality of linear grooves are aligned in parallel may further be subjected to hydrophilizing treatment.

Another example of the hydrophilic structure body that can pull in and hold the specimen by the capillary force can include a structure body in which a plurality of protrusions are arranged at spacings similar to the above. Specimen take-in portion 430 can be simultaneously formed at the time of fabricating the substrates. Alternatively, cotton or the like may be fixed to first concave portion 410 as specimen take-in portion 430 that is the hydrophilic structure body. Specimen take-in portion 430 may be a surface subjected to hydrophilizing treatment (surface treated with ordinary pressure plasma, surface having an electrically-charged coating material applied thereto, and the like).

In microchip 400 according to the present embodiment as well, the specimen take-in portion is provided on the microchip main body side (more specifically, within the opening of the microchip main body). Similarly to the first embodiment, microchip 400 according to the present embodiment can eliminate the conventional operational inconvenience and trouble of collecting the specimen using the capillary that is small and difficult to hold, and can save the conventional time and effort of loading the capillary having the specimen taken therein in the microchip. In addition, by forming first concave portion 410 and specimen take-in portion 430 to have a relatively large area, the fingertip or the like can be easily brought into contact with specimen take-in portion 430.

### Fourth Embodiment

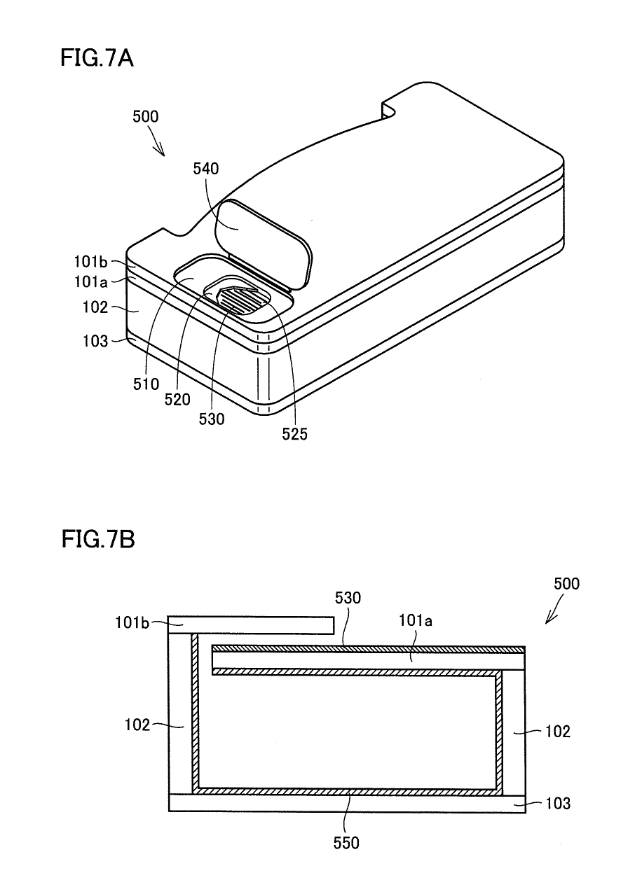

FIG. 7A is a schematic perspective view showing one example of a microchip according to the present embodiment, and FIG. 7B is a schematic cross-sectional view of an opening of the microchip. A microchip 500 shown in FIGS. 7A and 7B is a microchip formed by stacking and bonding four substrates of a first substrate-b 101b, a first substrate-a 101a, second substrate 102, and third substrate 103 in this order. Second substrate 102 can be a black substrate, and first substrates-a and -b 101a and 101b as well as third substrate 103 can be transparent substrates.

An opening is provided in surfaces of first substrates-a and -b 101a and 101b that are a part of a surface of microchip 500. This opening includes a first concave portion 510 provided in the surface of first substrate-b 101b, a second concave portion 520 provided within first concave portion 510, and a through hole 525 provided within second concave portion 520. The surface of first substrate-a 101a on the first substrate-b side is exposed at through hole 525.

A specimen take-in portion 530 is disposed within this opening (first and second concave portions 510 and 520 as well as through hole 525). More specifically, this specimen take-in portion 530 is configured by a region in which a plurality of linear grooves formed in the surface of first substrate-a 101a on the first substrate-b side are aligned in parallel. A gap is formed between first substrate-b 101b and first substrate-a 101a, and this region (specimen take-in portion 530) is connected by this gap to a fluid circuit [see FIG. 7B].

Microchip 500 includes a flat-plate-like lid portion 540 that can freely open and close the opening. In microchip 500, lid portion 540 has substantially the same shape as that of first concave portion 510, and when lid portion 540 is closed, lid portion 540 fits into first concave portion 510.

Similarly to microchip 100 shown in FIGS. 1A and 1B, lid portion 540 can be coupled by a hinge to the same member as the member having the opening, i.e., first substrate-b 101b. Together with the hinge, lid portion 540 is integrally molded with first substrate-b 101b, and all of lid portion 540, first substrate-b 101b and the hinge can be made of the thermoplastic resin described above by way of example. Although lid portion 540 is integrally molded with first substrate-b 101b in FIG. 7A, lid portion 540 may be integrally molded with first substrate-a 101a, second substrate 102 or third substrate 103. It is also possible to form lid portion 540 as a member different from a microchip main body and join this lid portion 540 to the microchip main body using the hinge.

A specific configuration of specimen take-in portion 530 configured by the region in which the plurality of linear grooves are aligned in parallel, and other examples of the hydrophilic structure body can be similar to those of specimen take-in portion 430 in the third embodiment, and description about specimen take-in portion 430 can be cited.

As described above, microchip 500 according to the present embodiment has one feature that microchip 500 has the hydrophilic structure body serving as specimen take-in portion 530 or the region subjected to hydrophilizing treatment on the surface of first substrate-a 101a on the first substrate-b side. The region having the hydrophilic structure body formed therein or the region subjected to hydrophilizing treatment may be the entire surface of first substrate-a 101a on the first substrate-b side, or may be a part of the surface of first substrate-a 101a on the first substrate-b side.

Generally, an inner wall surface of the fluid circuit of the microchip preferably has water repellency such that a liquid can smoothly move within the fluid circuit (this is not limited to the present embodiment and the same is applied as well to the other embodiments). Examples of a method for making the inner wall surface water-repellent can include a method for forming a water-repellent layer 550 made of a water-repellent agent on the inner wall surface as in the example shown in FIG. 7B, in addition to use of high water-repellent thermoplastic resin for the substrates constituting the microchip. In this case, one surface (surface on the first substrate-b side) of first substrate-a 101a used in the present embodiment is hydrophilic, and the other surface (surface constituting the fluid circuit) is water-repellent.

In microchip 500 according to the present embodiment as well, the specimen take-in portion is provided on the microchip main body side (more specifically, within the opening of the microchip main body). Similarly to the first embodiment, microchip 500 according to the present embodiment can eliminate the conventional operational inconvenience and trouble of collecting the specimen using the capillary that is small and difficult to hold, and can save the conventional time and effort of loading the capillary having the specimen taken therein in the microchip. In addition, by forming the opening (first and second concave portions 510 and 520 as well as through hole 525) to have a relatively large area, the fingertip or the like can be easily brought into contact with specimen take-in portion 530.

### Fifth Embodiment

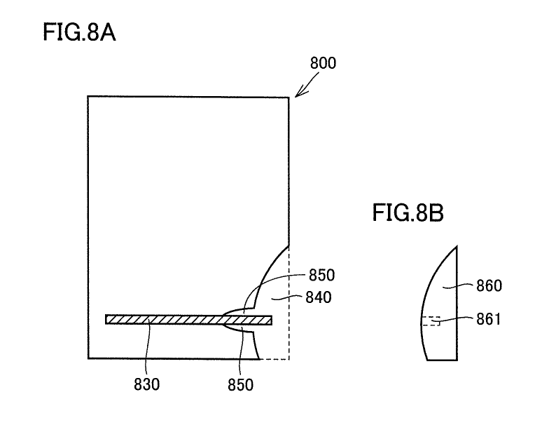

FIG. 8A is a schematic top view of one example of a microchip according to the present embodiment, and FIG. 8B is a schematic top view of a lid portion included in the microchip. A microchip 800 shown in FIGS. 8A and 8B can be a microchip of type A or type B, and the like.

Microchip 800 has, at one corner thereof, a notch portion 840 that is an opening provided in a surface of microchip 800. This notch portion 840 further has an insertion hole into which a specimen take-in portion 830 is inserted. Specimen take-in portion 830 that is a thin hollow tube is inserted into and fixed to the insertion hole. Specimen take-in portion 830 is inserted such that one end thereof protrudes into notch portion 840 and the other end thereof is connected to a fluid circuit inside microchip 800.

Microchip 800 includes a lid portion 860 that can freely open and close (seal/release) the opening (notch portion 840). In microchip 800, lid portion 860 can be freely attached to/detached from a microchip main body. In addition, lid portion 860 has, in a side surface thereof, an insertion hole 861 corresponding to an end of specimen take-in portion 830 protruding toward the notch portion 840 side. When the opening is closed by lid portion 860, the end of specimen take-in portion 830 is inserted into insertion hole 861. Lid portion 860 does not need to be freely attachable/detachable and may be coupled to the microchip main body such that at least a part of lid portion 860 can open and close the opening. An outer shape of lid portion 860 can, for example, be the same or substantially the same as a shape of notch portion 840.

The thin hollow tube used as specimen take-in portion 830 is preferably a hollow tube that can pull in and hold the specimen by the capillary force when the specimen is brought into contact with the one end of specimen take-in portion 830 protruding into notch portion 840, e.g., when the fingertip or the like having a drop of blood thereon is brought into contact with the one end of specimen take-in portion 830. For example, a commercially available capillary (made of glass), a tube having an inner wall subjected to anticoagulant treatment, strip-like cotton and the like can also be used, in addition to a capillary of thermoplastic resin having an inner wall subjected to hydrophilizing treatment. Specimen take-in portion 830 can be incorporated at the time of fabricating the microchip (at the time of bonding the substrates together). Alternatively, specimen take-in portion 830 may be integrally molded with the substrates constituting microchip 800.

As shown in FIG. 8A, a specimen reservoir 850 for storing the specimen that may flow out from specimen take-in portion 830 when the centrifugal force is applied to microchip 800 may be provided in a region in contact with notch portion 840 and around the insertion hole into which specimen take-in portion 830 is inserted.

In microchip 800 according to the present embodiment as well, the specimen take-in portion is provided on the microchip main body side (more specifically, within the opening of the microchip main body). Similarly to the first embodiment, microchip 800 according to the present embodiment can eliminate the conventional operational inconvenience and trouble of collecting the specimen using the capillary that is small and difficult to hold, and can save the conventional time and effort of loading the capillary having the specimen taken therein in the microchip. In addition, by forming the opening (notch portion 840) to have a relatively large area, the fingertip or the like can be easily brought into contact with specimen take-in portion 830.

<Modification>

Modifications of the microchip according to the present invention are shown in FIGS. 9A to 9C, 10, 11A and 11B, 12A and 12B, and 13A and 13B. Each of these microchips can be a microchip of type A or type B, and the like.

At one corner of a microchip main body 901, a microchip 900 shown in FIGS. 9A to 9C has an opening provided in a surface of microchip 900 and connected to a fluid circuit, and includes a lid portion 902 housed in this opening when lid portion 902 is closed [FIG. 9A]. Although lid portion 902 is a member different from microchip main body 901, lid portion 902 is coupled to microchip main body 901 by a fixed shaft 910, and can freely rotate around this fixed shaft 910 and can open and close the opening. FIG. 9B shows a state in which lid portion 902 is open.

Lid portion 902 includes a specimen take-in portion 903 configured by the structure body that holds the specimen by the capillary force. Specimen take-in portion 903 is housed in the opening when lid portion 902 is closed. Examples of the structure body that holds the specimen by the capillary force are as described above, and the cylindrical structure body is employed in microchip 900 [FIG. 9C]. The cylindrical structure body is provided with a slit (portion that does not have a cylindrical wall) in order that the specimen can be discharged from specimen take-in portion 903 by application of the centrifugal force.

In microchip 900, the specimen is housed in specimen take-in portion 903 of lid portion 902 (e.g., by bringing the fingertip or the like having a drop of blood thereon into contact with specimen take-in portion 903, the specimen can be housed), and thereafter, lid portion 902 is closed and the fluid treatment is performed.

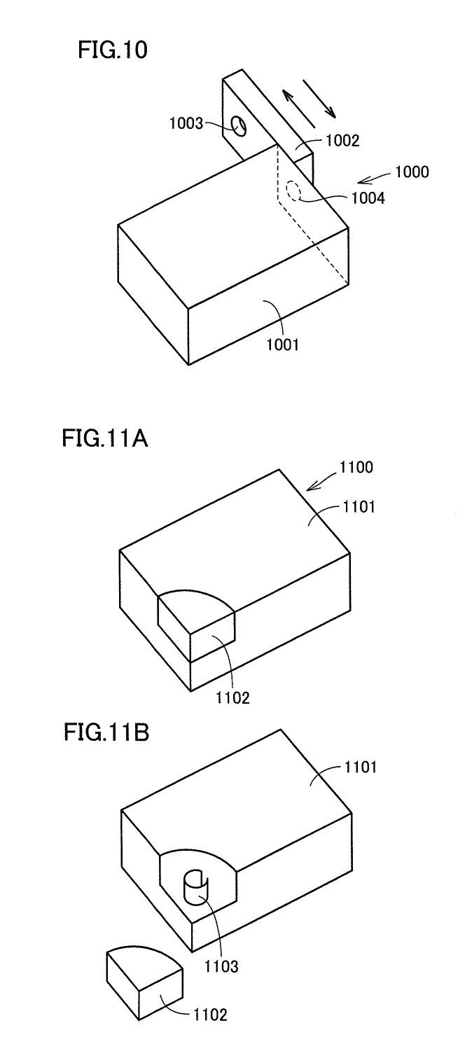

A microchip 1000 shown in FIG. 10 has, in one side surface of a microchip main body 1001, an opening 1004 connected to a fluid circuit, and a slidable type lid portion 1002 that opens and closes this opening 1004. A concave portion serving as a specimen take-in portion 1003 is provided in a surface of lid portion 1002 on the microchip main body 1001 side. Specimen take-in portion 1003 is arranged at a position where specimen take-in portion 1003 comes into contact with opening 1004, and preferably specimen take-in portion 1003 and opening 1004 match with each other when lid portion 1002 is slid to close opening 1004. In microchip 1000, the specimen is housed in specimen take-in portion 1003 of lid portion 1002, and thereafter, lid portion 1002 is closed and the fluid treatment is performed.

Instead of using the slidable type lid portion, a lid portion that opens and closes opening 1004 by rotation of the lid portion can also be used, for example.

A microchip 1100 shown in FIGS. 11A and 11B is a microchip including a freely attachable/detachable lid portion 1102. FIG. 11A is a schematic perspective view showing a state in which an opening is closed by lid portion 1102, and FIG. 11B is a schematic perspective view showing a state in which lid portion 1102 is removed and the opening is open.

At one corner of a microchip main body 1101, microchip 1100 has the opening (notch portion) provided in a surface of microchip main body 1101 and connected to a fluid circuit, and the cylindrical structure body as one example of a specimen take-in portion 1103 configured by the structure body that holds the specimen by the capillary force is disposed within this opening. The cylindrical structure body is provided with a slit (portion that does not have a cylindrical wall) in order that the specimen can be discharged from specimen take-in portion 1103 by application of the centrifugal force.

Microchip 1100 includes lid portion 1102 that can freely open and close (seal/release) the opening (notch portion). In microchip 1100, lid portion 1102 can be freely attached to/detached from the microchip main body. In microchip 1100, the specimen is housed in specimen take-in portion 1103 inside the opening, and thereafter, lid portion 1102 is closed and the fluid treatment is performed.

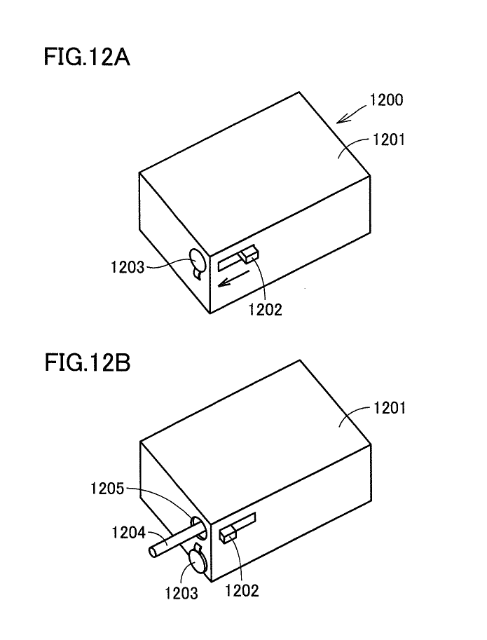

A microchip 1200 shown in FIGS. 12A and 12B has, in one side surface of a microchip main body 1201, an opening 1205 connected to a fluid circuit, and a lid portion 1203 that opens and closes this opening 1205. A specimen take-in portion 1204 capable of being freely retracted or pulled out is arranged within opening 1205. Specimen take-in portion 1204 is provided with a switch 1202 exposed at another side surface of microchip main body 1201, and by sliding this switch 1202 to the right and left directions by hand, specimen take-in portion 1204 can be pulled out from opening 1205 and can be retracted in opening 1205. Lid portion 1203 is opened in conjunction with pulling out specimen take-in portion 1204 from opening 1205.

Specimen take-in portion 1204 is preferably a hollow tube that can pull in and hold the specimen by the capillary force. For example, a commercially available capillary (made of glass), a tube having an inner wall subjected to anticoagulant treatment, and other tubes can also be used, in addition to a capillary of thermoplastic resin having an inner wall subjected to hydrophilizing treatment. In microchip 1200, specimen take-in portion 1204 is pulled out from opening 1205 by operating the switch (with this, lid portion 1203 is opened), and the specimen is housed in specimen take-in portion 1204, and thereafter, lid portion 1203 is closed and the fluid treatment is performed.

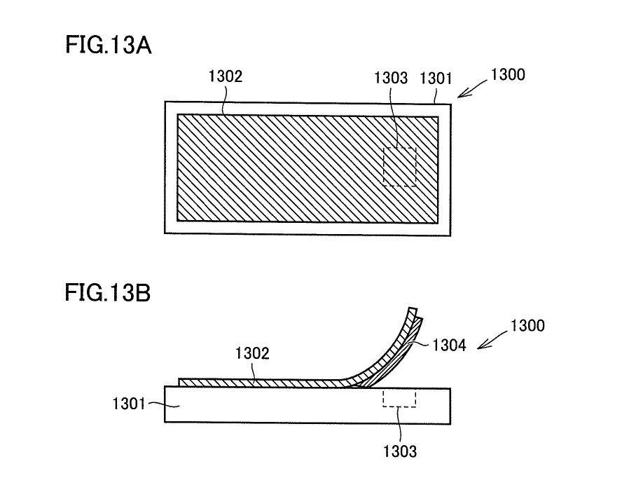

FIGS. 13A and 13B show a modification of the lid portion. As described above, the microchip normally has, in one surface thereof, a reagent injection port that is a through hole extending to a liquid reagent holding portion of a fluid circuit. After a liquid reagent is injected, the reagent injection port is sealed by affixing a sealing layer (e.g., a plastic film, a label, a seal and the like having an adhesive layer on one surface thereof) onto a surface of the microchip. In a microchip 1300 shown in FIGS. 13A and 13B, this sealing layer is used as the lid portion.

FIG. 13A is a schematic top view showing a state in which an opening 1303 of microchip 1300 is sealed by a lid portion 1302 serving as the aforementioned sealing layer, and FIG. 13B is a schematic cross-sectional view showing a state before sealing. Microchip 1300 includes a microchip main body 1301 having opening 1303 formed in one surface thereof (surface on the side having the reagent injection port), and lid portion 1302 serving as the sealing layer having a size that allows sealing of the reagent injection port and opening 1303. Although not shown, a specimen take-in portion described above by way of example is disposed within opening 1303.

For example, microchip 1300 in a state shown in FIG. 13B is provided to a user. The state shown in FIG. 13B is a state in which the reagent injection port is sealed by lid portion 1302, while opening 1303 is not sealed. A peel-off seal 1304 is affixed onto the adhesive layer formed in a region, which seals opening 1303, of a surface of lid portion 1302 on the microchip main body 1301 side. The specimen is housed in the specimen take-in portion, with opening 1303 being open as described above, and thereafter, the user peels off peel-off seal 1304, and opening 1303 is sealed by lid portion 1302 and the fluid treatment is performed.

Instead of affixing peel-off seal 1304, the adhesive layer formed in the region that seals opening 1303 may be configured by a weak adhesive that makes peel-off easier. In this case, microchip 1300 in a state shown in FIG. 13A (state in which opening 1303 is sealed) is provided to the user. The user peels off lid portion 1302 on opening 1303 and the specimen is housed in the specimen take-in portion, and thereafter, opening 1303 is again sealed by lid portion 1302 and the fluid treatment is performed.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A microchip including a fluid circuit composed of a space formed inside, and causing a liquid present in said fluid circuit to move within said fluid circuit by application of centrifugal force, the microchip comprising:
an opening provided in a surface of the microchip and connected to said fluid circuit;
a lid portion for opening and closing said opening; and
a specimen take-in portion provided at said lid portion or in said opening, for taking in a specimen.

2. The microchip according to claim 1, wherein
said specimen take-in portion is disposed at said lid portion such that said specimen take-in portion is housed in said opening when said lid portion closes said opening.

3. The microchip according to claim 1, wherein
said specimen take-in portion is disposed within said opening.

4. The microchip according to claim 1, wherein
said lid portion is integrally molded with a member forming any portion of the microchip other than said lid portion.

5. The microchip according to claim 4, wherein
said lid portion and said member are coupled by a hinge.

6. The microchip according to claim 1, wherein
said lid portion is composed of a member different from a portion of the microchip other than said lid portion.

7. The microchip according to claim 1, wherein
said specimen take-in portion includes a structure body for holding said specimen by capillary force.
